(19) United States
(12) Patent Application Publication
(10) Pub. No.: US 2026/0022609 A1
(43) Pub. Date: Jan. 22, 2026

(54) CURTAIN ROD

(71) Applicant: Changzhou Shunfei Plastic Co., Ltd, Changzhou (CN)

(72) Inventor: Jianxin XU, Changzhou (CN)

(73) Assignee: Changzhou Shunfei Plastic Co., Ltd, Changzhou (CN)

(21) Appl. No.: 19/342,501

(22) Filed: Sep. 27, 2025

(30) Foreign Application Priority Data
May 28, 2025 (CN) 202521071110.7

(51) Int. Cl. E06B 9/78; E06B 9/44; F16B 7/18

(52) U.S. Cl. CPC E06B 9/78; E06B 9/44; F16B 7/182; E06B 2009/785

(57) ABSTRACT

A curtain rod comprises a main rod, a fixing base and a rotary base. The fixing base and the rotary base are respectively disposed at both ends of the main rod; the main rod comprises a plurality of rod body sections and a connecting member configured to connect two adjacent rod body sections; the connecting member comprises a limiting section and two connecting sections symmetrically arranged on both sides of limiting section; the rod body section is correspondingly provided with a connection cavity for the engagement with the connecting section; shape of the limiting section matches cross-sectional shape of the rod body section; the connecting section is provided with a fixing component for securing rod body section; and side wall of the rod body section is recessed in a direction toward an axis of rod body section to form a fitting section and a avoidance section.

### CROSS-REFERENCE TO RELATED APPLICATIONS

This application claims priority to Chinese Patent Application No. 202521071110.7 with a filing date of May 28, 2025. The content of the aforementioned application, including any intervening amendments thereto, is incorporated herein by reference.

### TECHNICAL FIELD

The present invention relates to technical field of curtain rods, especially to a curtain rod.

### TECHNICAL BACKGROUND

The curtain rod is a decorative rod used to hang curtains. The curtain rod comprises a main rod and an auxiliary rod. The curtain fabric that matches the curtain rod is bent and sewn to form a fitting hole. The size of fitting hole is adapted to the auxiliary rod. The main rod is bent inward to form a mounting hole for auxiliary rod to fit in. The end face of the curtain fabric facing away from auxiliary rod fits with inner wall of the mounting hole, so that curtain fabric can be rolled up on the curtain rod by rotating the curtain rod.

In the prior art, when the curtain rod is long, the main rod is mostly transported in sections, and two adjacent sections of main rod are connected by a connecting section. However, in actual application, it is found that the connecting section used to connect two adjacent sections of main rod is mostly fixed to the main rod by bolts. After long-term use, the curtain fabric at the bolts will be rubbed and deformed, which will affect the service life and aesthetics of the curtain fabric.

### SUMMARY OF THE INVENTION

In order to extend the service life of curtain fabric matched with curtain rod, the present invention discloses a curtain rod.

The present invention discloses a curtain rod, which adopts following technical solution:

A curtain rod, comprising a main rod, a fixing base and a rotary base, wherein the fixing base and the rotary base are respectively disposed at both ends of the main rod; the main rod comprises a plurality of rod body sections and a connecting member configured to connect two adjacent rod body sections; the connecting member comprises a limiting section and two connecting sections symmetrically arranged on both sides of limiting section; the rod body section is correspondingly provided with a connection cavity for engagement with the connecting section; shape of the limiting section matches cross-sectional shape of the rod body section; the connecting section is provided with a fixing component for securing the rod body section; side wall of the rod body section is recessed in a direction toward an axis of rod body section to form a fitting section and a avoidance section; the fitting section is configured to engage with the auxiliary rod disposed on the curtain fabric; and the avoidance section is configured to accommodate fixing component.

By adopting the above technical solution, the fixing component for fixing the connecting member and the rod body section are stored in avoidance section. Then, in the actual application process, the curtain fabric can only contact outer wall of the main rod, which reduces the friction and deformation of curtain fabric by fixing component, thereby extending the service life of curtain fabric to a certain extent.

Preferably, the fixing component comprises a fixing bolt; the rod body section is formed with a fixing through hole that extends therethrough for receiving the fixing bolt; the connecting section is provided with a fixing hole configured to engage with fixing bolt; and when the rod body section moves to fit limiting section, the fixing through hole is in communication with the fixing hole.

By adopting the above technical solution, the rod body section and the connecting member are fixed by fixing bolts, which is convenient for operation.

Preferably, the fixing component further comprises a fixing rivet disposed on connecting section on either side of limiting section; the rod body section is provided with a mounting through hole configured to receive the fixing rivet; and the connecting section is provided with a mounting hole configured to be interference-fitted with fixing rivet.

By adopting the above technical solution, the fixing rivet and the mounting hole are interference-fitted, so that the connecting member and the corresponding rod body section form a non-detachable connection, thereby improving the reliability of fixing the connecting member to the rod body section. Before transporting the curtain rod, connecting section located on either side of limiting section needs to be fixed to the rod body section by fixing rivets. Then, at the installation site of the curtain rod, the operator only needs to fix the other end of rod body section to the rod body section by fixing bolts, which is convenient for the assembly of the curtain rod.

Preferably, the fixing base is rotatably connected with a fixing section that is configured to fit with connection cavity; the rotary base is rotatably connected with a bead wheel; a pull bead is slidably connected to the rotary base for controlling rotation of the bead wheel; a head stopper is coaxially disposed on the bead wheel matched with connection cavity; and the outer peripheral walls of the fixing section and the head stopper are both provided with fixing strips that fit the inner wall of the connection cavity.

Preferably, both the fixing base and rotary base are rotatably connected with a positioning section configured to fit with connection cavity; the positioning section is provided with a relief slot configured for engagement with the fitting section and the avoidance section; positioning section cooperating with fixing base is coaxially provided with a rotating post, and the fixing base is formed with a rotating through hole for the rotating post to be engaged;
the rotary base is coaxially provided with a rotary pin shaft which is in special shape, and the positioning section is formed with a pin shaft through hole configured to engage with the rotary pin shaft; and the rotary base is further provided with a rotary component configured to drive the rotation of rotary pin shaft.

Preferably, the rotary component comprises a meshed worm gear and a worm; the rotary base is provided with a housing configured to accommodate the worm gear and the worm; both the worm gear and the worm are rotatably mounted within housing; the rotary pin shaft is coaxially disposed on worm gear; and one end of the worm facing the ground is provided with a rotary pull ring.

By adopting the above technical solution, the main rod in present invention can be suitable for two rotation methods. When rotation of the main rod is achieved by pull bead, it effectively reduces the production costs of the fixing base and the rotary base, is easy to operate in actual use, and has a relatively high price-performance ratio. When the rotation of the main rod is achieved by rotary pull ring to drive worm to rotate, it effectively improves the safety of children during the use of the curtain rod and can improve the simplicity of the room to a certain extent.

Preferably, the fitting section and the avoidance section are symmetrically disposed on both radial sides of the rod body section.

By adopting the above technical solution, it is easy to process main body of the main rod and reduce the manufacturing difficulty.

Preferably, a guiding inclined surface is provided at one end of connecting section away from the limiting section.

By adopting the above technical solution, it facilitates embedding of connecting section into the connection cavity through the setting of the guiding inclined surface, thereby facilitating the assembly of curtain rod and improving the assembly efficiency of curtain rod to a certain extent.

The beneficial effects of one or more technical solutions of the present invention are as follows:
1. The fixing component used to fix the connecting member and the rod body section are stored in the avoidance section. In the actual application process, the curtain fabric can only contact the outer wall of the main rod, which reduces the friction and deformation of the fixing component on the curtain fabric and can extend the service life of the curtain fabric to a certain extent.
2. Before transporting the curtain rod, the connecting section on either side of the limiting section must be fixed to the rod body section by fixing rivets and fixing bolts. Then, at installation site of the curtain rod, the operator only needs to fix the other end of rod body section to rod body section by fixing bolts, thereby reducing the difficulty of assembling the curtain rod and facilitating the assembly of the curtain rod.
3. The main rod in the present invention can be applied to the two rotation methods. When rotation of main rod is achieved by pull bead, it effectively reduces production costs of fixing base and rotary base, is easy to operate in actual use, and has a relatively high price-performance ratio. When the rotation of the main rod is achieved by rotary pull ring to drive the worm to rotate, it effectively improves the safety of children during the use of the curtain rod and can improve the simplicity of the room to a certain extent.

### DESCRIPTION OF DRA WINGS

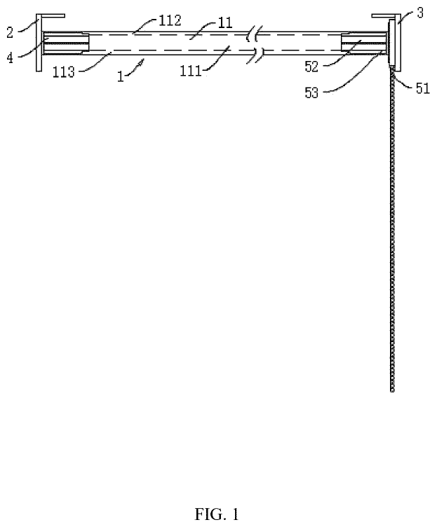

FIG. 1 is a schematic view of overall structure of Embodiment 1 of the present invention.

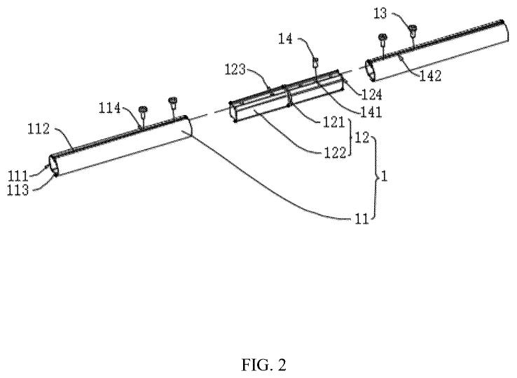

FIG. 2 is a schematic view of main rod structure in Embodiment 1 of the present invention.

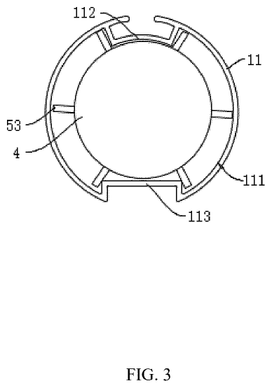

FIG. 3 is a schematic view showing the main rod in cooperation with the fixing section in Embodiment 1 of the present invention.

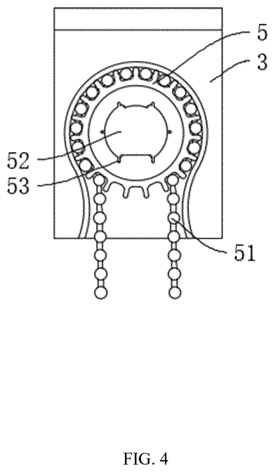

FIG. 4 is a schematic view of the rotary base structure in Embodiment 1 of the present invention.

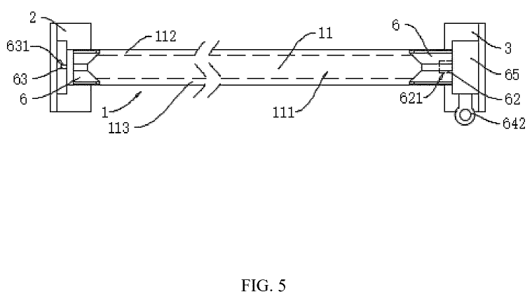

FIG. 5 is a schematic view of overall structure of Embodiment 2 of the present invention.

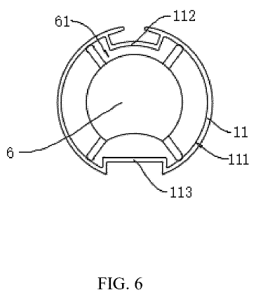

FIG. 6 is a schematic view showing main rod in cooperation with the positioning section in Embodiment 2 of the present invention.

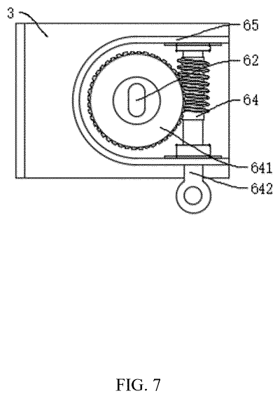

FIG. 7 is a schematic view of the rotary base structure in Embodiment 2 of the present invention.

Among them: 1. Main rod; 11. Rod body section; 111. Connection cavity; 112. Fitting section; 113. Avoidance section; 114. Fixing through hole; 12. Connecting member; 121. Limiting section; 122. Connecting section; 123. Fixing hole; 124. Guiding inclined surface; 13. Fixing bolt; 14. Fixing rivet; 141. Mounting hole; 142. Mounting through hole; 2. Fixing base; 3. Rotary base; 4. Fixing section; 5. Bead wheel; 51. Pull bead; 52. Head stopper; 53. Fixing strip; 6. Positioning section; 61. Relief slot; 62. Rotary pin shaft; 621. Pin shaft through hole; 63. Rotating post; 631. Rotating through hole; 64. Worm gear; 641. Worm; 642. Rotary pull ring; 65. Housing.

### DETAILED DESCRIPTION OF THE EMBODIMENTS

The present invention is further described in detail below in conjunction with FIG. 1 to FIG. 7.

### Embodiment 1

Referring to FIGS. 1 and 2, the embodiment of the present invention discloses the curtain rod, which comprises the main rod 1, wherein the main rod 1 comprises multiple rod body section 11 and connecting member 12 for fixing two adjacent sections of rod body section 11. The actual number of sections of the rod body section 11 depends on actual length of curtain rod, which is convenient for transporting the curtain rods with longer lengths. In the embodiment of the present invention, two sections of the rod body section 11 are selected as an example, and the rod body section 11 is made of stainless steel. Therefore, rod body section 11 has good strength, durability as well as corrosion resistance, can bear a large weight, and is not easily damaged when used to hang heavy curtains, thereby extending the service life of the curtain rod to a certain extent.

Referring to FIG. 2, the connecting member 12 comprises a limiting section 121 and a connecting section 122 symmetrically arranged on the both sides of the limiting section 121. The connecting section 122 is integrally formed with the limiting section 121. The connection cavity 111 for the connecting section 122 to be engaged is correspondingly provided on rod body section 11. The connecting section 122 can move along the connection cavity 111 to the limiting section 121 to fit with the rod body section 11, so that the shape of limiting section 121 is consistent with the cross-section of the rod body section 11, thereby ensuring the integrity and aesthetics of curtain rod after assembly.

Referring to FIG. 2, side wall of the rod body section 11 is recessed toward the direction of the axis of rod body section 11 to form fitting section 112 and avoidance section 113, wherein the fitting section 112 cooperates with the auxiliary rod provided on the curtain fabric, so that the curtain fabric can be stored on the main rod 1 when the main rod 1 rotates, thereby realizing the lifting and lowering of curtain fabric. The fixing component for fixing the rod body section 11 is provided on the connecting section 122, and the avoidance section 113 is used to store the fixing component. When curtain fabric is stored by the main rod 1, the curtain fabric is not easy to touch the fixing component, which effectively reduces the loss of the curtain fabric during actual use and prolongs the service life of curtain fabric. The fitting section 112 and the avoidance section 113 are symmetrically arranged on both sides of the radial direction of the rod body section 11, which facilitates the processing of the main body of the main rod 1 during actual operation and reduces the manufacturing difficulty.

The transition parts between the rod body section 11, the fitting section 112 and the avoidance section 113 are all arranged in an arc shape. The arc-shaped arrangement makes it difficult for the curtain rod to cause wear to the curtain fabric during actual use, thereby effectively extending the service life of curtain fabric. In addition, the assembler is not easily injured during actual assembly process, and the safety is relatively high.

Referring to FIG. 2, fixing component comprises fixing bolt 13, fixing through hole 114 for the fixing bolt 13 to pass through is provided on the rod body section 11, and fixing hole 123 matching with fixing bolt 13 is provided on the connecting section 122. When the rod body section 11 moves to fit with the limiting section 121, the fixing through hole 114 is connected with fixing hole 123. It should be noted that connecting member 12 in the present invention is made of plastic material, which effectively reduces use costs of the curtain rod. The connecting member 12 can be independently injection-molded or integrally injection-molded at one end of the rod body section 11. In the embodiment of the present invention, connecting member 12 is independently injection-molded. The fixing bolt 13 in the present invention can be an ordinary bolt or an expansion bolt. When the fixing bolt 13 is an ordinary bolt, during the injection molding process of the connecting member 12, an embedded component that matches with the thread of the fixing bolt 13 needs to be reserved to facilitate the fixing of the connecting member 12 and the rod body section 11. In the embodiment of the present invention, the fixing bolt 13 is an expansion bolt.

Referring to FIG. 2, the fixing component comprises the fixing rivet 14 arranged on the connecting section 122 on either side of the limiting section 121, mounting through hole 142 for the fixing rivet 14 to pass through is provided on the rod body section 11, and mounting hole 141 configured to form an interference fit with fixing rivet 14 is provided on connecting section 122, such that connecting member 12 and corresponding rod body section 11 form the non-detachable connection, thereby enhancing reliability of the connection between the connecting member 12 and the rod body section 11. Prior to transportation of the curtain rod, the connecting section 122 on either side of the limiting section 121 is firstly fixed to the rod body section 11 by fixing rivet 14 and fixing bolt 13. At the installation site, the operator only needs to secure the other end of the rod body section 11 to connecting member 12 using fixing bolt 13, thereby facilitating assembly of the curtain rod.

Referring to FIG. 2, guiding inclined surface 124 is provided at one end of the connecting section 122 away from limiting section 121. The setting of guiding inclined surface 124 facilitates embedding of connecting section 122 into connection cavity 111, thereby facilitating the assembly of the curtain rod and improving the assembly efficiency of the curtain rod to a certain extent.

Referring to FIGS. 1, 3 and 4, the curtain rod also comprises fixing base 2 and rotary base 3 respectively arranged at both ends of the main rod 1, and the fixing base 2 and the rotary base 3 are fixed to the wall structure by bolts. The cross section of the main rod 1 in the present invention is adaptable to two curtain fabric lifting mechanisms. In the embodiment shown, the fixing base 2 is rotatably connected with fixing section 4 configured to fit with the connection cavity 111, and the rotary base 3 is rotatably connected with bead wheel 5. The pull bead 51 is slidably connected to the rotary base 3 for controlling the rotation of the bead wheel 5. The head stopper 52 is coaxially disposed on the bead wheel 5 and is configured to fit with connection cavity 111. Fixing strips 53 are provided on the outer circumferential surfaces of both the fixing section 4 and the head stopper 52, and are configured to engage with the inner wall of the connection cavity 111. A plurality of fixing strips 53 are arranged in a circular array centered on the axis of the fixing section 4 or the head stopper 52. The fitting section 112 and the avoidance section 113 are engaged between two adjacent fixing strips 53. When the pull bead 51 is pulled, it drives bead wheel 5 to rotate, thereby causing the head stopper 52 to rotate the main rod 1. Since the fixing section 4 is embedded within the connection cavity 111, rotation of the main rod 1 also causes fixing section 4 to rotate relative to the fixing base 2, thereby improving the stability of curtain fabric lifting by rotation of the main rod 1. The present method of rolling curtain fabric is simple in operation and low in cost, thereby offering a high cost-performance ratio.

### Embodiment 2

Referring to FIGS. 5, 6 and 7, difference from Embodiment 1 lies in that both the fixing base 2 and rotary base 3 are rotatably connected with positioning section 6 configured to fit with connection cavity 111. The positioning section 6 is provided with the relief slot 61 configured for engagement with fitting section 112 as well as avoidance section 113. The specially-shaped rotary pin shaft 62 is coaxially disposed on rotary base 3, and the corresponding pin shaft through hole 621 is formed in the positioning section 6 for engagement with the rotary pin shaft 62. The rotary component is provided on rotary base 3 for driving rotation of rotary pin shaft 62. The positioning section 6 cooperating with fixing base 2 is coaxially provided with rotating post 63, and the fixing base 2 is formed with rotating through hole 631 configured to receive the rotating post 63. When the main rod 1 rotates, it drives the rotating post 63 to rotate within the rotating through hole 631, thereby enhancing the stability of rotation of the main rod 1.

Referring to FIG. 7, rotary component comprises meshed worm gear 64 and worm 641. The housing 65 is provided on rotary base 3 for accommodating the worm gear 64 and the worm 641, both of which are rotatably mounted within the housing 65. The rotary pin shaft 62 is coaxially and fixedly mounted on the worm gear 64. One end of the worm 641, facing the ground, is provided with rotary pull ring 642. In actual use, the rotary pull ring 642 can be rotated by an operating tool, thereby driving main rod 1 to rotate. The operating tool should be equipped with a hook configured to engage with rotary pull ring 642. By driving curtain fabric up and down in this way, compared with the method of using the pull bead 51, children are less likely to be injured, it is safer, and the overall interior of the house is more concise.

The above are all preferred embodiments of the present invention, and protection scope of the present application is not limited thereto. Therefore, any equivalent changes made according to the structure, shape, and principle of the present invention should be included in the protection scope of the present invention.

What is claimed is:

1. A curtain rod, comprising a main rod, a fixing base and a rotary base, wherein the fixing base and the rotary base are respectively disposed at both ends of the main rod; the main rod comprises a plurality of rod body sections and a connecting member configured to connect two adjacent rod body sections; the connecting member comprises a limiting section and two connecting sections symmetrically arranged on both sides of limiting section; each rod body section is correspondingly provided with a connection cavity for engagement with connecting section; shape of the limiting section matches cross-sectional shape of rod body section; the connecting section is provided with a fixing component for securing the rod body section; side wall of the rod body section is recessed in direction toward an axis of the rod body section to form a fitting section and a avoidance section; the fitting section is configured to engage with the auxiliary rod disposed on the curtain fabric; and the avoidance section is configured to accommodate the fixing component.

2. The curtain rod according to claim 1, wherein the fixing component comprises a fixing bolt; the rod body section is formed with a fixing through hole that extends therethrough for receiving the fixing bolt; the connecting section is provided with a fixing hole configured to engage with fixing bolt; and when the rod body section moves to fit the limiting section, the fixing through hole is in communication with the fixing hole.

3. The curtain rod according to claim 2, wherein the fixing component further comprises a fixing rivet disposed on the connecting section on either side of the limiting section; the rod body section is provided with a mounting through hole configured to receive the fixing rivet; and the connecting section is provided with a mounting hole configured to be interference-fitted with fixing rivet.

4. The curtain rod according to claim 1, wherein the fixing base is rotatably connected with a fixing section that is configured to fit with connection cavity; the rotary base is rotatably connected with a bead wheel; a pull bead is slidably connected to the rotary base for controlling rotation of bead wheel; a head stopper is coaxially disposed on the bead wheel matched with the connection cavity; and outer peripheral walls of the fixing section and the head stopper are both provided with fixing strips that fit the inner wall of the connection cavity.

5. The curtain rod according to claim 1, wherein both the fixing base and rotary base are rotatably connected with a positioning section configured to fit with the connection cavity; the positioning section is provided with a relief slot configured for engagement with the fitting section and the avoidance section; positioning section cooperating with the fixing base is coaxially provided with a rotating post, and the fixing base is formed with a rotating through hole for the rotating post to be engaged; the rotary base is coaxially provided with a specially-shaped rotary pin shaft, and the positioning section is formed with a pin shaft through hole configured to engage with the rotary pin shaft; and the rotary base is further provided with a rotary component configured to drive rotation of rotary pin shaft.

6. The curtain rod according to claim 5, wherein the rotary component comprises a meshed worm gear and worm; the rotary base is provided with a housing configured to accommodate the worm gear and the worm; both the worm gear and the worm are rotatably mounted within housing; the rotary pin shaft is coaxially disposed on worm gear; and one end of the worm facing the ground is provided with a rotary pull ring.

7. The curtain rod according to claim 1, wherein the fitting section and the avoidance section are symmetrically disposed on both radial sides of the rod body section.

8. The curtain rod according to claim 1, wherein a guiding inclined surface is provided at one end of the connecting section away from the limiting section.
